(19) United States
(12) Patent Application Publication
(10) Pub. No.: US 2011/0086321 A1
(43) Pub. Date: Apr. 14, 2011

(54) JAW HOLD OPEN APPARTUS

(76) Inventors: Lu Ann D. Finnegan, Saint Paul, MN (US); Donald R. Nixdorf, Minneapolis, MN (US)

(21) Appl. No.: 12/587,643

(22) Filed: Oct. 9, 2009

(51) Int. Cl. A61D 5/00

(52) U.S. Cl. 433/1

(57) ABSTRACT

This document discloses, among other things, an apparatus for preventing closure of an animal mouth. A harness is fitted around the neck and the lower jaw of the animal and maintains an intraoral piece at a position in the back of the mouth. It also includes a method for holding the animal's jaw open.

### TECHNICAL FIELD

This document pertains generally to animals, and more particularly, but not by way of limitation, to an animal jaw hold open apparatus.

### BACKGROUND

Animals, such as dogs, are often disposed to resist constraints imposed by their human handlers. For example, when providing canine dental care, a dog will often struggle to free itself from any effort to hold the head or jaw in a particular position. This tendency increases the risk of human or canine injury and it can lead to inadequate dental care.

### OVERVIEW

An apparatus according to the present subject matter includes a structure for holding the jaw of an animal in an open position in which the lower jaw (the mandible) is spaced apart from the upper jaw (the maxilla). The apparatus includes a harness. The harness includes an adjustable length neck portion and a jaw portion. The neck portion is configured for partial encirclement of the neck of the animal and the jaw portion is configured for passage through the mouth of the animal. The neck portion and the jaw portion are slidably coupled together. In addition, the jaw portion includes an intraoral piece. The intraoral piece is configured for insertion in the mouth of the animal.

The harness holds the intraoral piece in a position within the jaw that is independent of movement of the jaw. In addition, the harness is configured to resist attempts by the animal to eject the intraoral piece and configured to maintain the intraoral piece in a fixed position in the animal mouth.

The intraoral piece can be fabricated of materials such as rubber, plastic, leather, wood or combinations thereof In one example, a handle is either attached to the harness or attached to the intraoral piece. The handle is configured for grasping by a human hand. A particular type of harness known as a combination collar and muzzle humane training aid can be used. The harness can be coupled to the jaw portion (and thus, also the intraoral piece) by a quick-release attachment device. One example of a quick-release attachment device includes a fastener which is engaged and disengaged by rotating. The quick-release attachment can include a hook and loop type fastener.

A method of using the apparatus includes affixing the harness about the neck of the animal and includes positioning the jaw portion in a position such that the intraoral piece passes through the animal's mouth in a manner to prevent closure of the jaw. The harness can be positioned and fitted to the animal by engaging a hook and loop fastener or by engaging a buckle.

A method of manufacturing an apparatus for preventing closure of an animal's jaw that includes coupling the neck portion of a harness to a jaw portion of the harness and by providing an attachment device to allow the intraoral piece (of the jaw portion) to be coupled with the harness. The portions of the harness can be coupled by a sliding connector and the attachment device can include a quick-release fastener. The intraoral piece can be coupled to the harness by a sleeve.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a hold open apparatus worn by a dog.

FIG. 2 illustrates a hold open apparatus.

FIG. 3 illustrates a partial view of a hold open apparatus.

FIGS. 4A and 4B illustrate portions of an intraoral piece.

FIG. 5 illustrates a portion of a hold open apparatus.

FIGS. 6 and 7 illustrate views of an intraoral piece.

FIG. 8 illustrates a partial view of another embodiment of the hold open apparatus.

FIG. 9 illustrates another embodiment of a hold open apparatus.

FIG. 10 illustrates another embodiment of the hold open apparatus worn by a dog.

### DETAILED DESCRIPTION

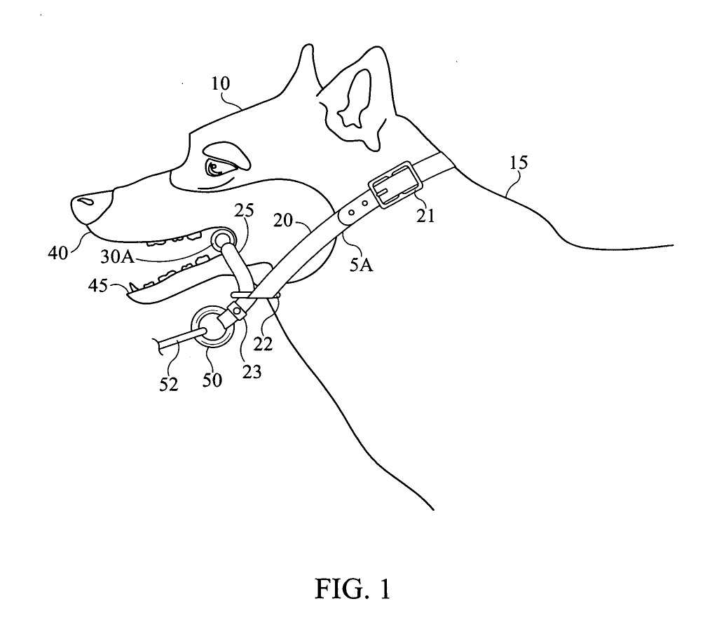

FIG. 1 illustrates an animal jaw hold open apparatus 5A worn by dog 10. Apparatus 5A includes jaw portion 25 and neck portion 20. Jaw portion 25 is positioned to pass through the mouth of dog 10. Neck portion 20 is positioned to partially encircle neck 15 of dog 10. Neck portion 20 is positioned behind, or below, the ears of the animal and jaw portion 25 is positioned to pass through the mouth at a position near the back of the mouth. Jaw portion 25 and neck portion 20 are joined underneath jaw 45 at fitting 22. Fitting 22 is sometimes referred to as a buckle, slide, or slider. Fitting 22 can be in the form of a ring or a ring with a divider bar segmenting the ring into two portions. When fitted to an animal, apparatus 5A is positioned such that fitting 22 is beneath the jaw of the animal.

In one example, ring 50 is attached to jaw portion 25. In the figure, ring 50 is attached to leash 52. In one example, ring 50 is eliminated and the jaw portion 25 is of a length that allows an operator to grasp and control the animal. Buckle 21 allows adjustment in the length of neck portion 20.

In the example illustrated, intraoral piece 30A is coupled to jaw portion 25. Jaw portion 25 is positioned within a lumen of a tubular element of intraoral piece 30A. Intraoral piece 30A is configured to prevent closure of jaw 45 relative to muzzle 40.

Apparatus 5A, as shown in the figure, includes a combination collar and muzzle training aid. One such example is known as a “Gentle Leader” however, other types of devices can also be used. Intraoral piece 30A can be coupled to, and cooperate with, such a training aid.

When fitted to an animal, apparatus 5A can facilitate oral or dental care. A tug or pull exerted on leash 52 will cause jaw portion 25 to exert a force on the lower jaw of the animal. Neck portion 20 stabilizes the position of fitting 22 through which jaw portion 25 slides. In this manner, intraoral piece 30A is cinched, or thrust tightly, into the lower jaw portion, thus holding the animal jaw in an open position. Accordingly, the danger of an operator suffering a bite injury is reduced.

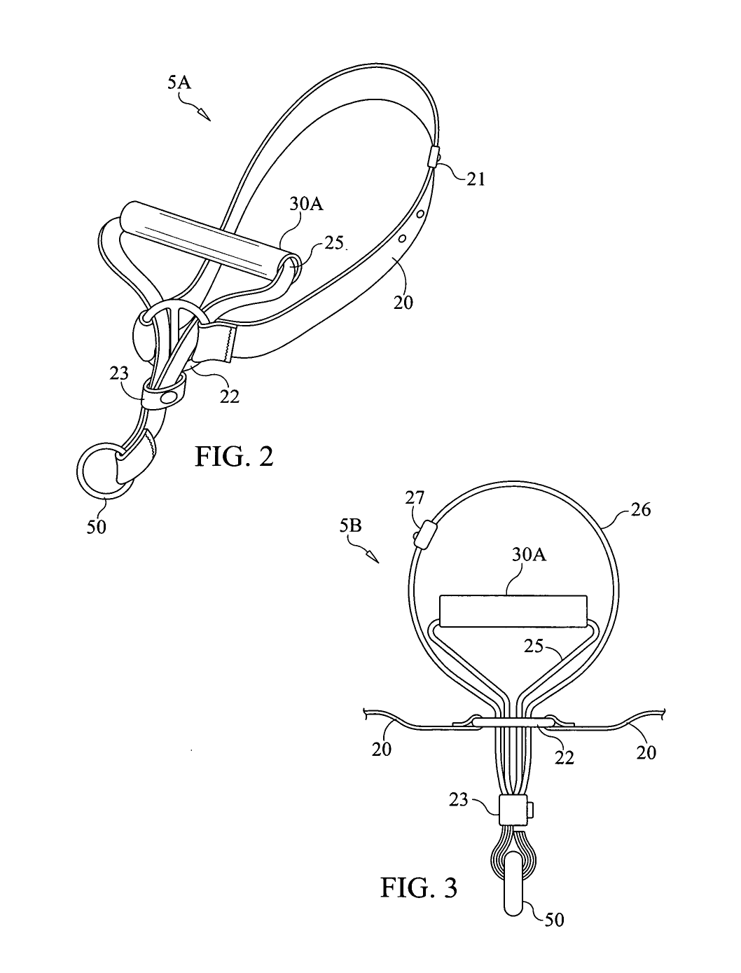

FIG. 2 illustrates a view of apparatus 5A. The length of neck portion 20 is adjustable at buckle 21. The two ends of neck portion 20 are non-adjustably, or non-slidably, affixed to fitting 22. The ends of neck portion 20 are looped and stitched through openings in fitting 22. Fitting 22 is in the form of a divided ring, however, it can be in the form of a rectangular three-bar connector.

Jaw portion 25 passes through the lumen of intraoral piece 30A. Jaw portion 25 also passes through one or more openings in fitting 22 as shown in the figure. Jaw portion 25 is slidably coupled to fitting 22. The ends of jaw portion 25 are preferably looped through ring 50 and preferably stitched together.

Clip 23 is adjustably secured to jaw portion 25. Clip 23 abuts fitting 22 and, when fitted to an animal, is positioned to provide a desired tension on jaw portion 25. In one example, clip 23 is adjusted on the jaw portion 25 to hold the intraoral piece in a fixed position within the animal's mouth.

FIG. 3 illustrates a partial view of apparatus 5B. Apparatus 5B includes neck portion 20, the end portions of which are shown in the figure. In addition, apparatus 5B includes jaw portion 25. Jaw portion 25 passes through intraoral piece 30A, fitting 22, and clip 23. It is also recognized that the intraoral piece may extend beyond the contours of the animal's mouth or wrap around to each end of the fitting.

Apparatus 5B also includes muzzle portion 26. A length of muzzle portion 26 is adjustable by buckle 27. Both muzzle portion 26 and jaw portion 25 pass slidably through the openings of fitting 22, are cinched by clip 23, and preferably affixed to ring 50. In the example illustrated, ring 50 is coupled to the portions by stitching.

When fitted to an animal, muzzle portion 26 passes over the top of the animal muzzle and jaw portion 25 passes through the mouth of the animal.

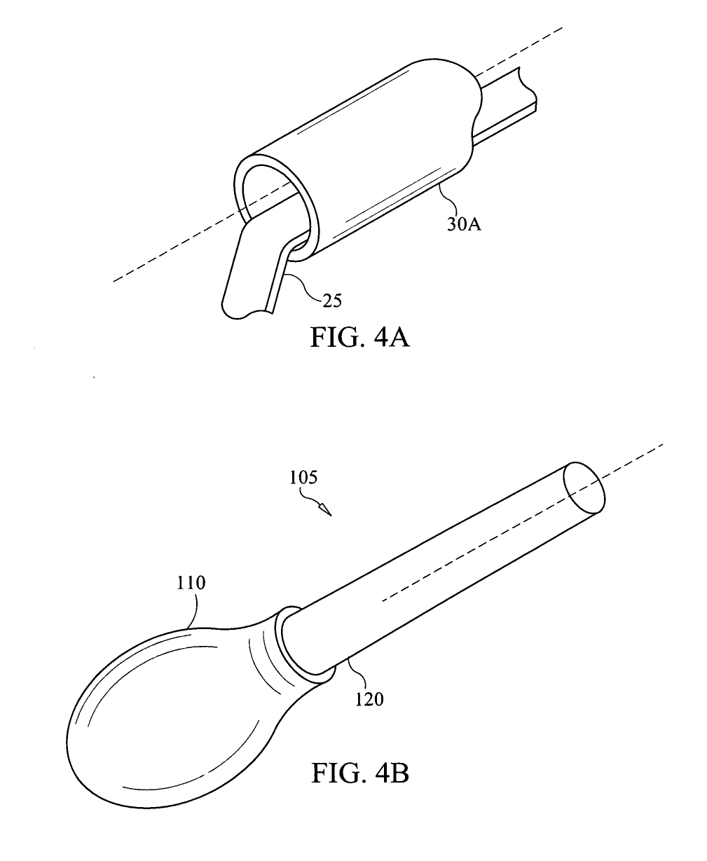

FIG. 4A illustrates a partial view of intraoral piece 30A and jaw portion 25. Jaw portion 25 passes through a lumen of intraoral piece 30A. Intraoral piece 30A is configured to prevent closure of the jaw of the animal when fitted as shown in FIG. 1.

In various examples, the present subject matter includes a handle. The handle is configured for grasping by a human hand in order to further assist in managing the behavior of the animal. The handle can be coupled to various portions of the apparatus including, for example, a portion of the harness or a portion of the intraoral piece. For example, the handle can be in the form of an extension of the intraoral piece.

FIG. 4B illustrates device 105 configured for coupling to intraoral piece 30A shown in FIG. 4A. In the example illustrated, device 105 includes rigid shaft 120 coupled to handle 110. Shaft 120 is configured to engage with the lumen of intraoral piece 30A and provide a means by which the animal can be controlled using apparatus 5A.

In one example, the present subject matter includes an anchor point that engages with a complementary structure. For example, the intraoral piece can include a structure configured to be anchored rigidly to a wall-mounted bracket and thereby hold the animal head in a fixed position without need of human control.

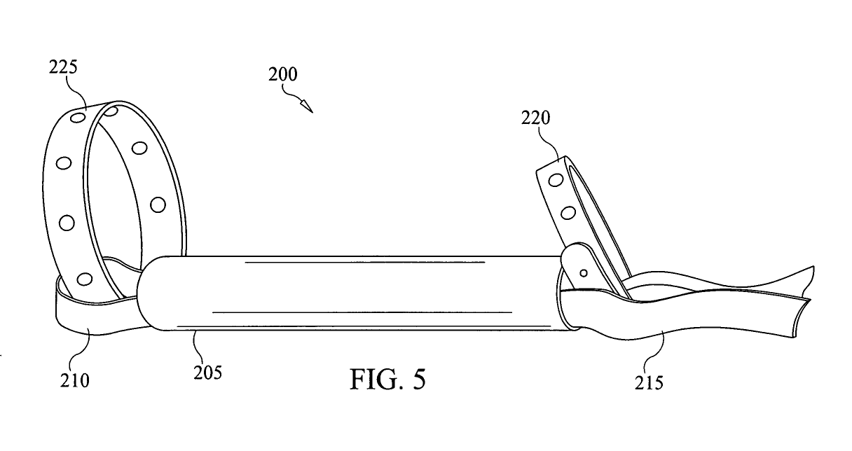

FIG. 5 illustrates intraoral piece 200. Intraoral piece 200 includes tubular portion 205. Tubular portion 205 is configured to resist a crushing force from the animal. In one example, tubular portion 205 includes a segment of plastic (such as PVC) tubing. A strap positioned in tubular portion 205 has bight 210 and ends 215 stitched and configured to couple with strap 225 and strap 220. Strap 225 and strap 220 are arranged as loops that engage portions of apparatus 5A. Other structures can be used to affix intraoral piece 200 to apparatus 5A.

The intraoral piece can have a textured or smooth surface and can be fabricated of various materials. In one example, the material for the intraoral piece is selected to have structural rigidity that resists crushing under the jaw force exerted by the animal and yet resilient enough to prevent injury to the animal. In addition, the intraoral piece has sufficient rigidity to resist expulsion by the animal. For example, a dog may attempt to eject the apparatus by manipulating its tongue or jaw. Some material examples include rubber, plastic, leather, or wood.

Various examples of the present subject matter are contemplated. For example, the apparatus can be configured to operate in conjunction with a training aid that engages both the neck and the snout of an animal. One example of such a training aid is available under the product name Gentle Leader and in general, includes a sliding coupler under the snout and a ring for coupling to a leash or tether. In this example, an intraoral piece includes attachment fittings to couple with the structure of the training aid. The intraoral piece can be used with the training aid or the training aid can be used independent of the intraoral piece.

One example of the present subject matter is configured as a stand-alone apparatus and includes a harness having an intraoral piece.

The intraoral piece can be of various configurations. In various examples, the intraoral piece is generally round in section and has a uniform outside diameter or has a graduated outside diameter. In various examples, the intraoral piece may include a non-circular geometric section, such as square, rectangular, or triangular.

In one example, the intraoral piece resembles the capital letter “H” having an elongate center section that spans the jaw transversely and end sections that are configured to hold the animal jowls apart.

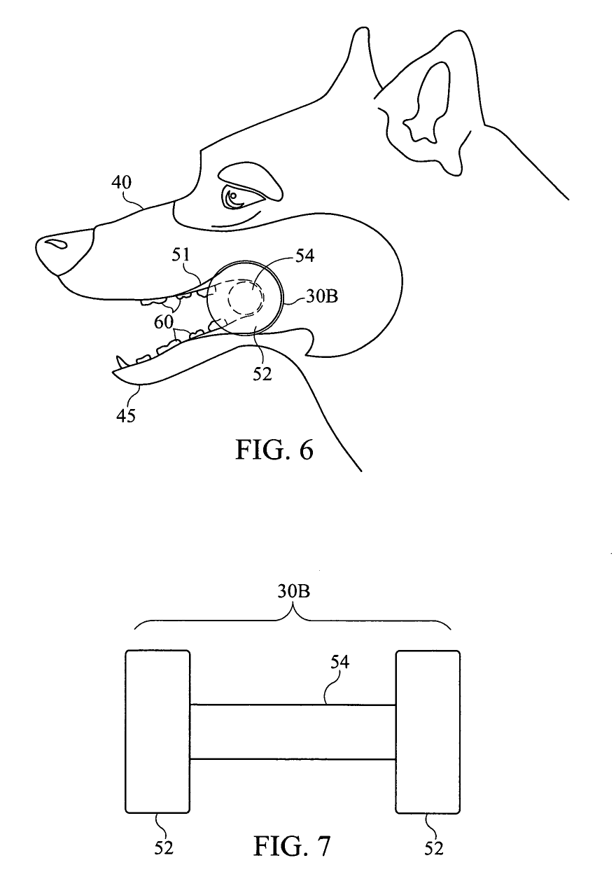

FIG. 6 illustrates intraoral piece 30B. For clarity, the harness, straps, buckles, and other structures are omitted. Intraoral piece 30B, also shown in FIG. 7, is configured as an “H” with center segment 54 having a smaller diameter than end segments 52. End segments 52 are configured to support the jowls of the animal, thereby exposing the teeth, as shown in FIG. 6. The figure also illustrates placement of the intraoral piece 30 at a position in the back of the mouth and behind teeth 60 of the animal. Upper jaw 40 and lower jaw 45 are held apart by intraoral piece 30B.

In various examples, the center section of the intraoral piece is rigid or flexible. Flexible examples include a cord, cable, chain or other linkage that enables a center section to articulate or rotate.

The neck portion and the snout portion of the harness cooperate together to stabilize the position of the intraoral piece within the back corner of the animal jaw. The harness also serves to resist ejection of the intraoral piece by the animal.

In one example, the harness is configured to maintain the intraoral piece in a position that is independent of movement of the head or jaw of the animal.

The harness can be fabricated of various materials. For example, leather, fabric, or synthetic products can be used and the materials can be in the form of a strap, webbing, belting, rope, cordage, lines, or other structures. The harness can include elastic or inelastic materials.

The harness can include various fittings or devices including length adjusters (such as a three-bar adjuster), snaps, buckles, hook and loop fasteners, or other such structures.

The present subject matter can be used for a variety of purposes. By way of examples, such an apparatus may be useful when administering dental care (such as teeth brushing), when administering medical care (such as delivery of a medicament), when training an animal (such as to acclimate the animal to a particular odor, taste or other sensation), or when educating an animal handler.

The intraoral piece can be configured to engage one or both sides of the animal jaw. The intraoral piece is configured to be positioned behind the rear molars and prevent closure of the jaw. One example includes an intraoral piece that has a displaced center portion. The center portion can be displaced in a forward direction (towards the front of the animal), or displaced in a direction above or below the muzzle. In one example, the intraoral piece includes an arched or open segment that increases the difficulty for the animal to eject the piece by tongue manipulation.

When the jaw is held in the open position, the animal is likely rendered less powerful and will naturally resist or attempt to eject any foreign object. This resistance can include rapid movement of the head and manipulating the tongue to eject the object. The present subject matter is configured to maintain the intraoral piece in a position in the jaw that is relatively fixed without regard to head position and to oppose ejection by tongue or jaw manipulation.

The neck portion, jaw portion, or muzzle portion can have length adjusters. When coupled to the animal, the neck portion partially encircles the neck and the jaw portion passes through the mouth of the animal. The neck portion and the snout portion can be coupled together by a buckle, snap, fitting, stitching or other structure. In addition, the harness can be coupled to the intraoral piece by a buckle, snap, fitting, stitching or other structure. In addition, various quick-release attachment devices are contemplated for the different couplings of the present subject matter. For example, a quarter-turn fastener or twist-on/off type of coupling can be used. In one example, the attachment device includes a hook and loop fastener. Such attachment devices can also serve to adjust the length of a member.

In one example, the intraoral piece includes a sleeve component and an inner member. The sleeve component is integral with the harness or coupled to the harness by an attachment device. The inner member can be removable and include a round section of material having a handle disposed on one end as illustrated in the figure.

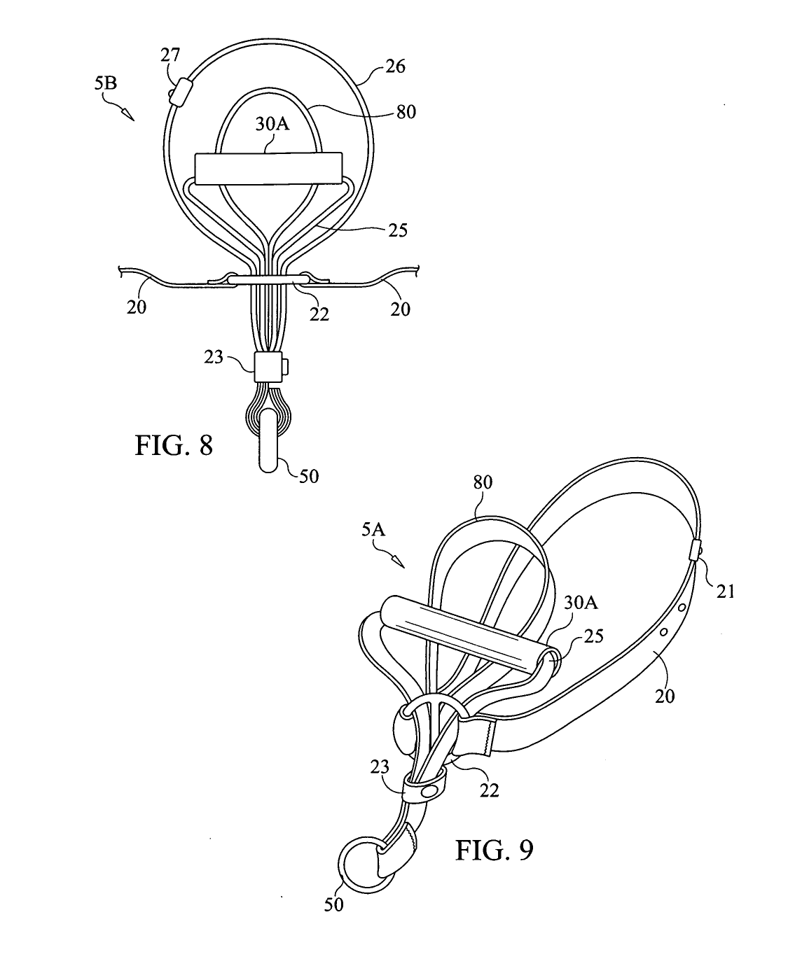

FIGS. 8-10 illustrate another embodiment of the animal jaw hold open apparatus 5A of FIGS. 1-3.

FIG. 8 illustrates a partial view of the embodiment that incorporates a strap 80 with apparatus 5B of FIG. 3.

FIG. 9 illustrates another view of apparatus 5A of FIG. 2 incorporating the strap that is usable above the snout of the animal.

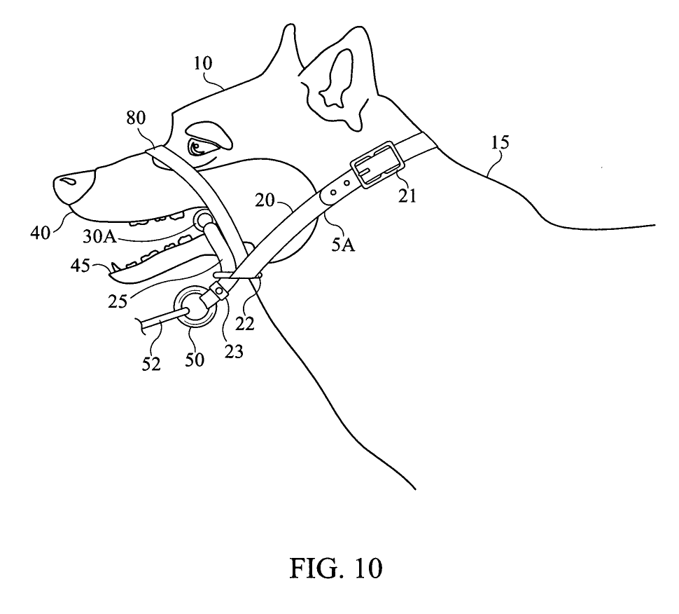

FIG. 10 illustrates the embodiment as worn by dog 10 similar to the presentation of FIG. 1. In the present embodiment, a strap 80 is preferably incorporated for use on the animal over the snout as illustrated. It is reasonable that strap 80 may be formed to incorporate at least an adjustable means to allow for effective use on different sizes of animals.

Other configurations for the apparatus are also contemplated. For example, different forms of sliding connectors and configurations of straps are also contemplated. For example, one example includes a tie strap between the muzzle portion and the neck portion and configured for positioning atop the head of the animal. In one example, the muzzle portion is coupled to the neck portion and not slidably engaged with fitting 22.

In one example, the intraoral piece is configured specifically to the shape of a dog's jaw. In one example, the intraoral piece includes a food, drug or other substance that administers nutrition or medicine to the animal. The intraoral piece can, for example, be porous, perforated or impregnated with a food or drug. In one example, the intraoral piece includes toothpaste or other hygienic product. The intraoral piece can be fabricated of a consumable or digestible material.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

1. An apparatus for holding a jaw of an animal in an open position, the apparatus comprising:
a harness having a neck portion and a jaw portion, the neck portion configured for partial encirclement of a neck of the animal and the jaw portion configured to pass through a mouth of the animal and configured to slidably engage the neck portion; and
the jaw portion having an intraoral piece configured for insertion in the jaw of the animal, thereby preventing closure of the jaw, the intraoral piece coupled to the harness.

2. The apparatus of claim 1 wherein the harness maintains the intraoral piece in a position within the jaw that is independent of movement of the jaw.

3. The apparatus of claim 1 wherein the harness is configured to maintain the intraoral piece in a fixed position in the mouth.

4. The apparatus of claim 1 wherein the intraoral piece includes at least one of rubber, plastic, leather, and wood.

5. The apparatus of claim 1 further including a handle affixed to at least one of the harness and the intraoral piece, the handle configured for grasping by a human hand.

6. The apparatus of claim 1 wherein the harness includes a combination collar and muzzle humane training aid.

7. The apparatus of claim 1 wherein the intraoral piece is coupled to the harness by a quick-release attachment device.

8. The apparatus of claim 1 wherein the quick-release attachment device includes a fastener which is engaged and disengaged by rotating.

9. The apparatus of claim 1 wherein the quick-release attachment device includes a hook and loop type fastener.

10. The apparatus of claim 1 wherein a strap is incorporated for use over the snout of the animal.

11. A method of holding a jaw of an animal in an open position, the method comprising:
affixing a harness about a neck of the animal and a lower jaw of the animal, the harness having a neck portion configured to partially encircle the neck and a jaw portion configured to pass through a mouth of the animal, the neck portion slidably coupled to the jaw portion; and
positioning an intraoral piece in a manner to prevent closure of the jaw, the intraoral piece coupled to the harness.

12. The method of claim 11 wherein affixing the harness includes coupling at least one of a hook and loop fastener and a buckle.

13. A method of manufacturing an apparatus for preventing closure of an animal jaw, the method comprising:
slidably coupling a neck portion of a harness to a jaw portion of the harness, the neck portion configured to encircle the neck and the jaw portion configured to pass through a mouth of the animal; and
providing an attachment device to allow coupling of an intraoral piece with the harness, the intraoral piece configured for placement in the mouth and to prevent closure of the jaw.

14. The method of claim 13 wherein coupling the neck portion to the jaw portion includes engaging a sliding connector.

15. The method of claim 13 wherein providing the attachment device includes providing a quick-release fastener.

16. The method of claim 13 wherein providing the attachment device includes providing a sleeve for receiving the intraoral piece.
